(19) United States
(12) Patent Application Publication
(10) Pub. No.: US 2020/0305575 A1
(43) Pub. Date: Oct. 1, 2020

(54) Rotary pressing cosmetic pen

(71) Applicant: Dongguan Xingri Packaging Products Technology Co., LTD., Dongguan (CN)

(72) Inventor: Junxing Luo, Dongguan (CN)

(73) Assignee: Dongguan Xingri Packaging Products Technology Co., LTD., Dongguan (CN)

(21) Appl. No.: 16/396,675

(22) Filed: Apr. 27, 2019

(30) Foreign Application Priority Data
Mar. 30, 2019 (CN) 201910253743.2

(51) Int. Cl. A45D 34/04; B43K 5/18; B43K 23/12; B43K 8/02; B43K 8/04

(52) U.S. Cl. CPC A45D 34/042; B43K 5/1818; B43K 23/12; A45D 2200/055; B43K 5/189; B43K 8/04; B43K 8/022

(57) ABSTRACT

The present invention relates to a rotary pressing cosmetic pen includes a pen tube, a material assembly, a pressing assembly and a discharging assembly; the pressing assembly includes a cylinder, a button cover, an outer ring and an inner ring; the cylinder rotately connects to the lower end of the pen tube; the outer ring is fixed in the cylinder; the button cover is inserted into the outer ring and stucked therein along the circumferential direction of the outer ring; one end of inner ring is inserted between the outer ring and the button cover, the other end of inner ring is inserted into the lower end of the pen tube and stucked therein along the circumferential direction of the pen tube; the inner ring is also provided with spiral grooves; the button cover is provided with clasps inserting into the spiral grooves and sliding therein.

### CROSS-REFERENCE TO RELATED APPLICATIONS

This application claims the benefit of priority from Chinese Patent Application No. CN201910253743.2, filed on Mar. 30, 3019. The content of the aforementioned application, including any intervening amendments thereto, is incorporated herein by reference in its entirety.

### TECHNICAL FIELD

The present disclosure relates to the technical field of cosmetics, in particular, to a rotary pressing cosmetic pen.

### BACKGROUND

When the female friends make up with makeup products, for example, powder, eye shadow, powder base, they often use smear tools with latex cotton body. The user needs take the smear tools with their hand to take appropriate amount of makeup products, for example eye shadow, powder, stored in the container. The makeup products, for example, powder, eye shadow, powder base, are usually stored in a special storage container. Each time they need to open the storage container, take out the smear tool to use, it is more inconvenient. Moreover, the makeup materials exposes to the air, it is inevitably pollution, oxidation, resulting in loss of efficacy.

To resolve the problems, Chinese patent CN201811406773.4 disclose a pressing type liquid makeup pen, it includes a brush head assembly, a pressing assembly, a nut, a pen body and a pen cover, which are arranged in the coaxis. The brush head assembly is fixed at the top end of the pen body, and the pen cover is detachable arranged outside of the brush head assembly. One end of the pressing assembly is seally inserted the inside of the pen body, and the inside of the pen body between the pressing assembly and the brush head assembly forms a holding space for storing the makeup material, and the nut is arranged on the outer side of the pressing assembly. The nut is clamped to the inside of the end of the pen body. There is an H height gap between the nut end and the pen body end, and within the gap there is a detachable clamping ring. When used for the first time, remove the clamping ring and push the nut. The nut drives the pressing assembly to move H distance toward the brush head assembly, the nut again clamps with the pen body, and then presses the pressing assembly to extrude the makeup material to the brush head. This makeup pen is convenient for users and saves users a lot of time.

The patent provides a pressing assembly to squeeze the makeup material in the pen body into the brush head assembly, which solves the problem that the makeup material is exposed to the air. However, the inventor realizes that after removing the clamping ring, there is no limited protection for the nut, and when it is not need to use, the external force may also push the nut and extrude the material.

### SUMMARY

In order to overcome the short comings of the prior art, the present disclosure provides a rotary pressing cosmetic pen, which includes a tube, a button cover and a cylinder, the cylinder contains makeup material. By rotating the cylinder, the button cover is extended out from or retracted into the cylinder, by pressing the button cover, the makeup material is extruded out from the cylinder. And the rotary pressing cosmetic pen is provided with pressing protection for the button cover, which can prevent the makeup material from extruding out when it is not need to use, therefor it avoids the makeup material from exposing in the air and polluting. It is convenient to use. The structure of the parts is simple and the production cost is low.

The technical proposals of the present disclosure are as follows: a rotary pressing cosmetic pen includes a pen tube including front portion and rear portion spaced in an axial direction and containing makeup material, a material assembly received in the pen tube, a pressing assembly arranged at the rear portion of the pen tube and a discharging assembly arranged at the front portion of the pen tube. The pressing assembly includes a cylinder, a button cover, an outer ring and an inner ring. The cylinder rotately connects to the rear portion of the pen tube; the outer ring is fixed in the cylinder; the button cover is inserted into the outer ring and stucked along the circumferential direction of the outer ring; one end of inner ring is inserted between the outer ring and the button cover, the other end of inner ring is inserted into the rear portion of the pen tube and stucked along the circumferential direction of the pen tube; the inner ring is also provided with spiral grooves; the button cover is provided with clasps inserted into the spiral grooves and slide in it; the cylinder is rotated to drive the outer ring and the button cover to rotate; the clasps slide up and down in the spiral grooves, thus the button cover is retracted into or extended out from the cylinder.

Rotate the cylinder to drive the button cover to extend out from the pen tube; press the button cover to push the inner ring, therefor pushing the material assembly and causing the material in the pen tube to be extruded out through the discharging assembly; then the material assembly is reset under the action of a spring to reverse push the inner ring and the button cover extending out from the cylinder; then reversely rotate the cylinder to drive the button cover to retract into the pen tube; the button cover is limited protect within the cylinder, even if press the pressing assembly, the makeup material cannot be extruded out.

The cylinder is sheathed out of the rear portion of the pen tube with a connecting tube, the connecting tube is provided with a first clasp, the cylinder is provided with blocks, the blocks and the first clasp hold each other to prevent the cylinder falling off from the connecting tube.

The outer ring is placed in the cylinder and held by the cylinder; the inner wall of the cylinder is provided with a second clasp holding the outer ring to prevent the outer ring from falling off the cylinder; the inner wall of the cylinder is also evenly distributed with a plurality of first bulges along its axial direction, and the outer wall of the outer ring is also provided with a plurality of second bulges along its axial direction, the first bulges and the second bulges hold each other to prevent the outer ring from rotating.

The outer ring is arranged outside of the button cover, both of which are placed in the cylinder. And the button cover can slide in the outer ring along its axial direction so that the bottom of the button cover extends out from or retracts into the cylinder.

The button cover is grooved with a third clasp in the middle of its outer wall; the bottom periphery of the cylinder extends inward to form a first step ring; the first step ring blocks the third clasp thereby preventing the button cover from falling off the outer ring; the bottom periphery of the outer ring extends inward to form a second step ring matching the outer wall of the button cover and blocking the third clasp.

The second step ring is provided with a slide block; the outer wall of the button cover is provided with a slide slot matching the slide block, thereby the button cover can move up and down along its axis in the outer ring, but it can not rotate along its circumferential direction.

Preferably, the inner ring is provided with a second sliding block, and the inner wall of the opening of the connecting tube is provided with a second slide slot matching the second slide block.

The material assembly includes the connecting tube, the outer wall of the connecting tube is provided with a large ring and a small ring; the large ring adapts the opening of the rear portion of the pen tube; the inner wall of the pen tube is provided with a limited ring matched with the small ring; so that the connecting tube and the pen tube hold each other.

The connecting tube is provided with a convex zone on its outer wall close to the small ring, and the inner wall of the pen tube is provided with convex strips matching with the convex zone, the convex strips and the convex zone hold mutually, thereby preventing the connecting tube from rotating in the pen tube.

The material assembly includes a lower rotating shaft, an upper rotating shaft, a spring, a cylinder cover, a rod and a piston; the lower rotating shaft and the upper rotating shaft are placed in the connecting tube; the connecting tube is provided with an inner convex ring; the upper part of the inner convex ring is provided with a vertical tooth portion; the lower rotating shaft has a lower cylinder and a lower tooth portion arranged on the lower cylinder; the lower tooth portion and the vertical tooth portion are clamped mutually to prevent the lower rotating shaft from rotating in its circumferential direction, the lower cylinder passes through the inner convex ring touch the inner ring.

The top of the lower tooth portion is arranged as a continuous V-shaped tooth; the upper rotating shaft has an upper cylinder and a limit plate arranged in the middle of the upper cylinder, from which extends the upper tooth portion; the upper cylinder inserts the lower tooth portion, and the bottom of the upper tooth portion is an oblique tooth matching the V-shaped tooth.

The connecting tube is also provided with a wall hole above the convex zone; the upper end of the connecting tube is provided with the connecting cover, the connecting cover is provided with clasps to connect the wall hole; the connecting cover is also provided with a thread hole at its center; the spring is sheathed out of the upper rotating shaft with one end against the limit plate and the other end against the connecting cover.

The rod has a threaded body portion, the opposite side faces of the threaded body portion are set as planes; one end of the thread body portion is a cylinder end, the other end of it is provided with an end cover, and a top cover is arranged above the end cover; the upper rotating shaft is provided with a flat cavity; the threaded body portion passes through the connecting cover and fits with the threaded hole; the thread body portion passes through the flat cavity and the lower rotating shaft and extends into the inner ring.

The piston is slide arranged in the pen tube, which is pushed by the top rod end of the rod and slides up in the pen tube.

the discharging assembly is arranged at one end of the pen tube; the end of the pen tube is provided with a threaded port; the discharging assembly comprises a nozzle and a pen head; the nozzle includes a thread tube and a thin tube portion arranged on the thread tube, the thread tube is connected with the threaded port; the pen head are fixed on the thread tube.

The pen head is shaped in a sloping surface, a arc surface or a spherical sphere.

The discharging assembly is arranged at the front portion of the pen tube, it includes a pen head, a brush arranged within the pen head, a nozzle, a plug, a spring, a steel ball and a seal plug; the front portion of the pen tube is provided with a threaded opening, and the pen head is provided with an internal thread, which is sheathed out of the thread opening; the sealing plug is inserted in the thread opening and sealed it, the sealing plug is provided with a tube cover in its middle covering the thread opening; bottom of the sealing plug is provided with a first through hole, and inner cavity of the sealing plug is hollow; the steel bead is received at the through hole, the plug is placed in inner cavity of the sealing plug; the plug is provided with a plug hole the spring is also provided between the steel ball and the plug, the nozzle includes a plug end, a thin tube end, and an end cover between them, the insertion end inserts the sealing plug, the thin tube end insert the brush; the end cover covers the seal plug, the brush includes a brush seat and soft hair arranged on the brush seat, the brush seat is provided with a second through hole, the thin tube end insert into the soft hair through the second through hole, the tube contains fluid material, which is flows out by pressing the pressing assembly and the material assembly, the fluid material flows through the threaded opening, the first through hole, the cavity of said sealing plug, the plug hole of the plug, the thin tube and flows into the brush, the brush infiltrate fluid material and used for making up.

The material assembly is a piston assembly, including a piston cover, a piston, a piston tube, a discharging cover and vacuum pump core; top surface of the inner ring is provided with a plunger, the piston cover is provided with a cylinder hole matching with the plunger; the piston cover seals bottom of the pen tube; the piston is placed in the pen tube and it can slide in the pen tube; the pen tube contains makeup material; the piston tube is contained in the pen tube, top of the pen tube is provided with a thin neck, the thin neck is provided with an external thread, and top of the thin neck is provided with a tube port; the discharging cover includes a groove-shaped cover with a through hole at its top and a threaded ring in it, the threaded ring connected with side walls of the outer cover through a plurality of stiffeners; the inner wall of the thread ring is provided with internal threads sheathed out of the thin neck through the external thread and the internal threads to assemble the discharging cover on the top of the pen tube.

The vacuum pump core is assembled at the through hole of the discharging cover and inserted and sealed the piston tube through the tube port; pressing the pressing assembly to push the piston tube to move towards the discharging assembly, and then, driven by spring of the vacuum pump core, the piston tube resets to generate negative pressure; the material in the pen tube is extruded out of the discharging assembly through the vacuum pump core.

The discharging assembly comprises a cover, a piece and a cotton head; the cover has a first connecting section, a second connecting section and a third connecting section set as a step-by-step arrangement; the inner wall of the first connecting part is provided with a thread, and connects outer part of the upper connecting head through the thread; the second connecting section connects the first connecting section and the third connecting section; the third connecting section has a thin neck and an external opening; the cotton head has a circular head, a neck and a base; said base is placed in the second connecting section and is matched to the third connecting section; the neck passes through the thin neck of the third connecting section; the circular head extends out from the thin neck, bottom of thin neck and opening of the outer opening fit each other; center of the cotton head is provided with material hole through the circular head, the neck and the base, the piece comprises a sealing cover, a sleeve ring and an discharging rod; the sealing cover is housed in the second connecting section of the cover, and upper end surface of the sealing cover is provided with the sleeve ring; the sleeve ring is arranged in the second connecting section and is connected to the base; the discharging rod is arranged on the sleeve ring; the discharging rod is inserted in the material hole.

The advantages of the present disclosure is that the rotary pressing cosmetic pen causes the button cover to extend out from or retract into the cylinder by rotating the cylinder, and the material extrusion is realized by pressing the button cover. The rotary pressing cosmetic pen is also provide with a pressing protection for the button cover to prevent the material from extruding out from the pen tube, it avoids material waste and pollution.

### BRIEF DESCRIPTION OF THE DRAWINGS

FIG. 1 is a perspective view of the rotary pressing cosmetic pen according to the present disclosure. The view shows the state in which the button cover retracts into the cylinder.

FIG. 2 is another perspective view of the rotary pressing cosmetic pen according to the present disclosure. The view shows the state in which the button cover extends out from the cylinder.

FIG. 3 is a cross-section along the section line A-A according to the FIG. 1.

FIG. 4 is an exploded view of the pressing assembly and the material assembly of the rotary pressing cosmetic pen according to the present disclosure.

FIG. 5 is a perspective view of the cylinder of the rotary pressing cosmetic pen according to the present disclosure.

FIG. 6 is a perspective view of the outer ring of the rotary pressing cosmetic pen according to the present disclosure.

FIG. 7 is an exploded view of a connecting cylinder of the rotary pressing cosmetic pen according to the present disclosure.

FIG. 8 is a section view of a pen tube of the rotary pressing cosmetic pen in the present disclosure.

FIG. 9 is a cross-section along the section line B-B according to the FIG. 1.

FIG. 10 is another section view of the rotary pressing cosmetic pen according to the present disclosure.

FIG. 11 shows a partial view of the rotary pressing cosmetic pen according to the present disclosure.

FIG. 12 is another exploded view of the rotary pressing cosmetic pen according to the present disclosure.

FIG. 13 is a perspective view of the rotary pressing cosmetic pen according to the second embodiment of the present disclosure.

FIG. 14 is a perspective view of the rotary pressing cosmetic pen according to the third embodiment of the present disclosure.

FIG. 15 is an exploded view of FIG. 14.

FIG. 16 is a section view of FIG. 13.

FIG. 17 is a perspective view of the vacuum pump core according to the second embodiment of the present disclosure.

FIG. 18 is an exploded view of the vacuum pump core according to the present disclosure.

FIG. 19 is a perspective view of f the rotary pressing cosmetic pen according to another embodiment of the present disclosure.

FIG. 20 is a section view according to FIG. 19.

FIG. 21 is an exploded view according to FIG. 19.

### DETAILED DESCRIPTION OF EMBODIMENTS

The followings will further descript the present invention with the embodiments, which are the preferable embodiments in the present invention.

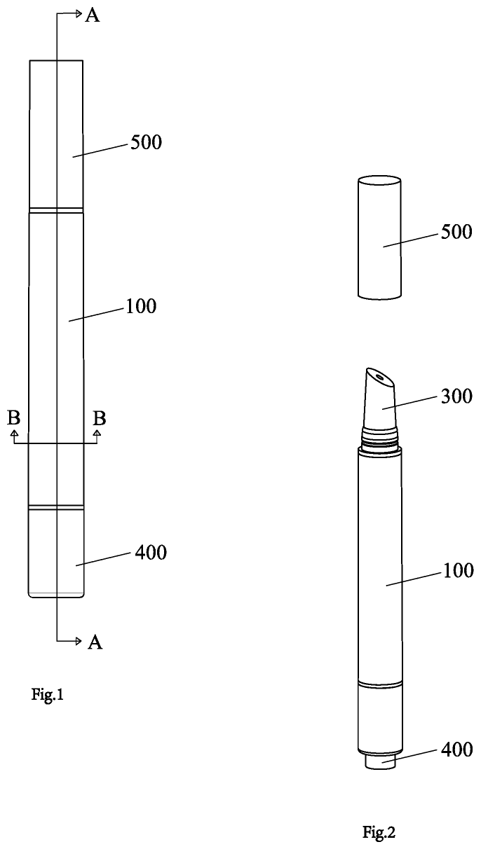

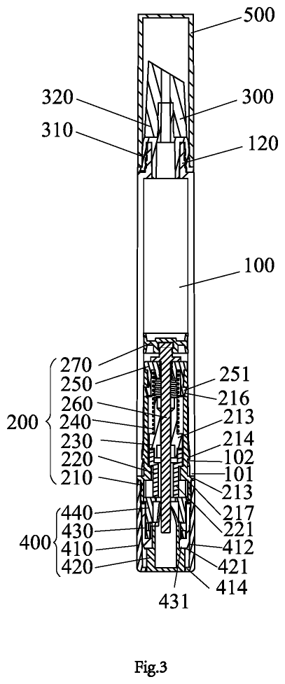

Referring to FIG. 1, FIG. 2 and FIG. 3, a rotary pressing cosmetic pen includes a pen pen tube 100 including front portion and rear portion spaced in an axial direction and containing makeup material, a material assembly 200 received in the pen tube, a pressing assembly 400 arranged at the rear portion of the pen tube and a discharging assembly 300 arranged at the front portion of the pen tube. The pressing assembly 400 includes a cylinder 410, a button cover 420, an outer ring 430 and an inner ring 440. The cylinder 410 rotately connects to the rear portion of the pen pen tube 100. The outer ring 430 is fixed in the cylinder 410. The button cover 420 is inserted into the outer ring 430 and stucked therein along the circumferential direction of the outer ring 430, therefor the button cover 420 can slide along the axial direction of the outer ring 430, but it cannot rotate along the circumferential direction of the outer ring 430. One end of inner ring 440 is inserted between the outer ring 430 and the button cover 420, the other end of inner ring 440 is inserted into the rear portion of the pen tube 100 and stucked therein along the circumferential direction of the pen tube 100, therefor the inner ring 440 can slide along the axial direction of the pen tube 100, but it can not rotate along the circumferential direction of the pen tube 100. The inner ring 440 is also provided with spiral grooves. The button cover 420 is provided with clasps 423, which are inserted into the spiral grooves and can slide therein. The cylinder 410 is rotated to drive the outer ring 430 and the button cover 420 to rotate. The clasps 423 slide up and down in the spiral grooves, thus the button cover 420 is retracted into or extended out from the cylinder 410.

The material pen tube 100 contains the movable liquid or the emulsion material. Rotate the cylinder 410 to drive the button cover 420 to extend the pen tube 100. Then press the button cover 420 to push the inner ring 440, therefor pushing the material assembly 200 and causing the material in the pen tube 100 to be extruded out through the discharging assembly 300. Then the material assembly 200 is reset under the action of a spring to reverse push the inner ring 440 and the button cover 420, which is extends the cylinder 410. Repeatedly press the button cover 420 so that sufficient material is extruded for use. After that, reversely rotate of the cylinder 410 to drive the button cover 420 to retract to the pen pen tube 100. The button cover 420 is limitly protected within the cylinder 410, even if the external force continues to press the pressing assembly 400, the makeup material cannot be extruded out.

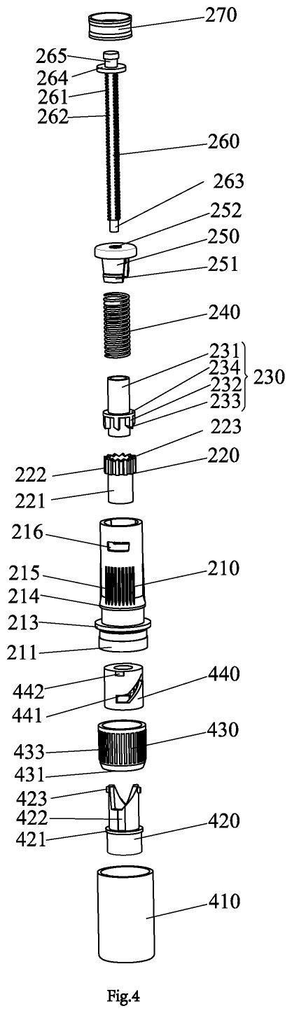

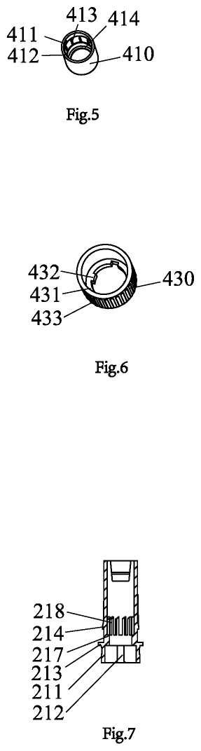

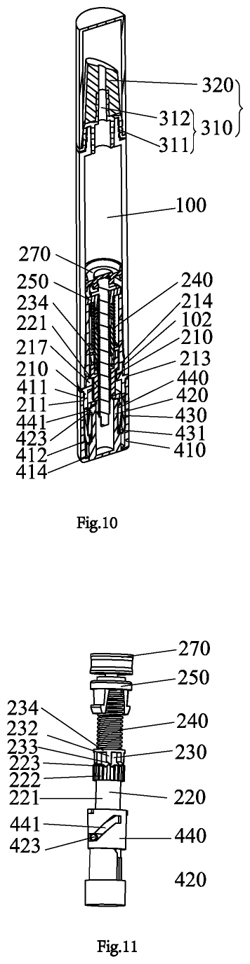

Referring to FIG. 4, FIG. 5 and FIG. 10, the cylinder 410 can be directly sheathed out of the rear portion of the pen tube 100, or it can be sheathed there with a middleware, such as a connecting tube 210. The cylinder 410 is sheathed out of the bottom of the connecting tube 210 and it can rotate around the connecting tube 210. A first clasp 211 and blocks 411 are respectively arranged on the cylinder 410 and the connection tube 210 to prevent the two from falling off. Specifically, referring to FIG. 4 and FIG. 5, the out wall of the opening of the connecting tube 210 is provided the first clasp 210, the inner wall of the upper opening of the cylinder 410 is provided the blocks 411. The first clasp 210 and the blocks 411 hold each other to prevents the cylinder 410 and the connecting tube 210 from falling off.

Referring to FIG. 3 and FIG. 10, the outer ring 430 is placed in the cylinder 410 and held by the cylinder 410. Specifically, the inner wall of the cylinder 410 is provided with a second clasp 412 holding the outer ring 430 to prevent the outer ring 430 from falling off the cylinder 410. Preferably, referring to FIG. 5 and FIG. 6, the inner wall of the cylinder 410 is also evenly distributed with a plurality of first bulges 413 along its axial direction, and the outer wall of the outer ring 430 is also provided with a plurality of second bulges 433 along its axial direction, the first bulges 413 and the second bulges 433 hold each other to prevent the outer ring 430 from rotating.

The outer ring 430 is arranged outside the button cover 420, both of which are placed in the cylinder 410 together. And the button cover 420 can slide in the outer ring 430 along the axial direction so that the bottom of the button cover 420 extends out from or retracts into the cylinder 410.

Referring to FIGS. 4 and 5, the button cover 420 is grooved with a third clasp 421 in the middle of the outer wall. The bottom periphery of the cylinder 410 extends inward to form a first step ring 414. Referring to FIG. 3 and FIG. 10, the first step ring 414 blocks the third clasp 421 to prevent the button cover 420 from falling off the outer ring 430. The bottom periphery of the outer ring 430 extends inward to form a second step ring 431 matching with the outer wall of the button cover 420 and blocking the third clasp 421. When the button cover is pressed by an external force, the button cover 420 is completely retracted the cylinder 410, the second step ring 431 blocks the third clasp 421 and the outer ring 430 blocks the button cover 420 so that it cannot rise along the axial direction.

The outer ring 430 also limits the button cover 420 to prevent its rotation. Specifically, referring to FIG. 6, a sliding block 432 is arranged on the second step ring 431. Referring to FIG. 4, a sliding slot 422 is arranged on the outer wall of the button cover 420. The sliding block 432 matches the sliding slot 422 so that the button cover 420 can move up and down along its axis within the outer ring 430, but it cannot be rotated along its circumferential direction.

The inner ring 440 is arranged between the button cover 420 and the outer ring 430. Specifically, referring to FIG. 4, the inner ring 440 is grooved and the wall of the inner ring 440 is symmetrically provided with two spiral grooves 441. The button cover 420 is symmetrically provided with two spiral ramps, and the top of the spiral ramp is provided with a clasp 423. Referring to FIGS. 10 and 11, the clasp 423 is placed in the spiral grooves 441 and can slide therein. When the cylinder 410 is rotated, the cylinder 410 jams the the second bulges 433 of the outer ring 430 by the first bulges 413, thereby driving the outer ring 430 to rotate synchronously. The outer ring 430 matches the slide slot 422 on the button cover 420 through the slide block 432 to drive the the button cover 420 to rotate. The clasp 423 of the button cover 420 rotates and lifts within the spiral groove 441 of the inner ring 440, thereby enabling the button cover 420 to extend out from or retract into the cylinder 410. When the button cover 420 extends out from the cylinder 410, the clasp 423 lies at the bottom of the spiral groove 441. Press the button cover 420 to drive it retract into the cylinder 410. The button cover 420 pushes the inner ring 440 up through the clasp 423 to push the material assembly 200. When the third clasp 421 touches the second step ring 431, the button cover 420 cannot continue to rise, the inner ring 440 also rises to the highest point and cannot continue to push the material assembly 200. When the cylinder 410 is rotated so that the button cover 420 retracts into the cylinder 410, the clasp 423 is located at the top of the spiral groove 441. At this time, the third card ring 421 touches the second step ring 431, and the button cover 420 cannot continue to rise. Even apply pressure to button cover 420, it can not push the inner ring to rise, the pressing protection is achieved. It avoids the makeup material from extruding out from the tube pen after the the button cover 420 is retracted into the cylinder 410.

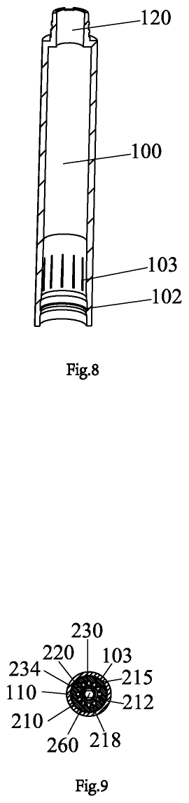

Preferably, referring to FIG. 4, the inner ring 440 is provided with a second sliding block 442, and referring to FIG. 7, the inner wall of the opening of the connecting tube 210 is provided with a second sliding slot 212 matching the second slide block 442. The inner ring 440 slides in the connecting tube 210 under the push of the button cover 420 and it cannot be rotated in a circumferential direction.

Referring to FIG. 4, the material assembly 200 comprises the connecting tube 210, a lower rotating shaft 220, a upper rotating shaft 230, a spring 240, a cylinder cover 250, a rod 260 and a piston 270.

A portion of the connecting tube 210 is inserted and clamped with the pen tube 100. Specifically, the outer wall of the connecting tube 210 is provided with a large ring 213 and a small ring 214. The large ring 213 adapts the lower opening 101 of the pen tube 100. The inner wall of the pen tube 100 is provided with a limited ring 102 matched with the small ring 214 so that the connecting tube 210 and the pen tube 100 are clamped so that the connecting tube 210 cannot be lifted or lowered in the tube 101.

Referring to FIG. 4, FIG. 8 and FIG. 9, the connecting tube 210 is provided with a convex zone 215 on the outer wall close to the small ring 214, and the inner wall of the pen tube 100 is provided with convex strips 103 matching with the convex zone 215, the convex strips 103 and the convex zone 215 are held mutually, thereby preventing the connecting tube 210 from rotating in the pen tube 100.

Referring to FIGS. 4 and 3, the connecting tube 210 is also provided with a wall hole 216 above the convex zone 215. The upper end of the connecting tube 210 is provided with the connecting cover 250, the connecting cover 250 is provided with clasps 251 to connect the wall hole 216. The connecting cover 250 is also provided with a thread hole 252 at the center.

Referring to FIG. 4, the connecting tube 210 is provided with an inner convex ring 217. The upper part of the inner convex ring 217 is provided with a vertical tooth portion 218.

Referring to FIGS. 3 and 10, the lower rotating shaft 220 and the upper rotating shaft 230 are placed in the connecting tube 210. Referring to FIGS. 4 and 9, the lower rotating shaft 220 has a lower cylinder 221 and a lower tooth portion 222 arranged on the lower cylinder 221. The lower tooth portion 222 and the vertical tooth portion 218 are clamped mutually to prevent the lower rotating shaft 220 from rotate in a circumferential direction. Referring to FIGS. 3 and 10, the lower cylinder 221 passes through the inner convex ring 217 to touch the inner ring 440. When the inner ring 440 rises, the lower rotate shaft 220 is pushed up synchronously. The top of the inner ring 440 rises to touch the inner convex ring 217, the it arrives to the highest position and is blocked, it cannot continue to rise. Even pressing the button cover 420, the inner ring 440 can not rise.

Referring to FIG. 4, the top of the lower tooth portion 222 is arranged as a continuous V-shaped tooth 223.

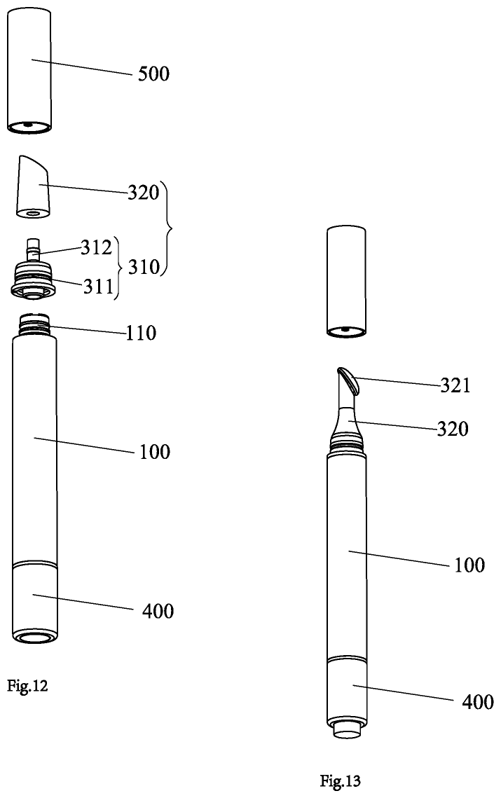

Referring to FIG. 4, the upper rotating shaft 230 has an upper cylinder 231 and a limit plate 234 arranged in the middle of the upper cylinder 231, from which extends the upper tooth portion 232. Referring to FIG. 3, FIG. 10 and FIG. 12, the upper cylinder 231 inserts the lower tooth portion 222, and the bottom of the upper tooth portion 232 is an oblique tooth 233 matching the V-shaped tooth 223. When the lower cylinder 220 rises within the connecting tube 210, the V-shaped tooth 223 pushes the oblique tooth 233 in a direction perpendicular to its bevel surface, causing the lower cylinder 230 to rotate while rising.

Referring to FIG. 3, FIG. 10 and FIG. 12, the spring 240 is sheathed out of the upper rotating shaft 230 with one end against the limit plate 234 and the other end against the connecting cover 250. When the upper shaft 230 rotates up, the spring 240 is compressed, and then the spring 240 is reset and elongated, pushing the upper shaft 230 down. The upper shaft 230 pushes the lower shaft 220 down. The lower shaft 220 pushes the inner ring 440 and the button cover 420 down, thereby the button cover 420 extends the cylinder 410.

Referring to FIGS. 3, 4 and 10, the rod 260 has a threaded body portion 261, the opposite side faces of the threaded body portion 261 are set as planes 262. One end of the thread body portion 261 is a cylinder end 263, the other end of it is provided with an end cover 264, and a top cover 265 is arranged above the end cover 264. The threaded body portion 261 passes through the connecting cover 250 and fits with the threaded hole 251. The thread body portion 261 passes through the upper rotating shaft 230, the lower rotating shaft 220 and extends into the inner ring 440. Referring to FIG. 9, the upper rotating shaft 230 is provided with a flat cavity 234, which limit the the threaded body portion 261, the threaded body portion is capable of lifting and lowering within the inner cavity 234, but it cannot rotate.

When the upper rotating shaft 230 rotates up, the rod 260 rotates up synchronously. When the upper rotating shaft 230 falls under the action of the spring 240, the rod 260 is blocked by the thread hole 25 and cannot be dropped synchronously. Repeatedly press the button cover 420, the rod 260 is rose.

The piston 270 is slide arranged in the pen tube 100, which is pushed by the top rod end 265 of the tooth rod 260 and slides up in the pen tube 100. Specifically, the piston 270 is provided with a cavity matching the top rod end 265.

The pen tube 100 is provided with a makeup material, and under the impetus of the piston 270, the makeup material extrudes the pen tube 100.

Referring to FIG. 3, FIG. 12, the discharging assembly 300 is arranged at one end of the pen tube 100. Specifically, the end of the pen tube 100 is provided with a threaded port 120. The discharging assembly 300 comprises a nozzle 310 and a pen head 320. The nozzle 310 includes a thread tube 311 and a thin tube portion 312 arranged on the thread tube 311, the thread tube 311 is connected with the threaded port 120. The pen head 320 are fixed on the thread tube 311. It should be understood that the fixed methods can be threaded connection, clamping, etc. The thin tube portion 31 is inserted the pen head 320.

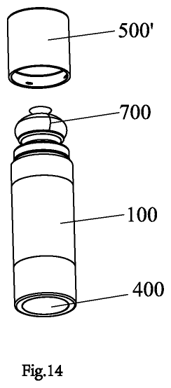

The shape of the pen head 320 may be designed in various ways, as shown in FIG. 12, the coating portion 321 at the top of the pen head 320 can be arranged as a sloping surface suitable for lip smearing, as shown in FIG. 13, and it may also be arranged as a arc surface suitable for smearing around the eye or face. As shown in FIG. 14, it can also be set to a spherical sphere.

It should be understood that in the above embodiments the pressing assembly 400 pushes the material assembly 200 to extrude the material in the material pen tube 100 through the discharging assembly 300. The material assembly 200 and the discharging assembly 300 are not limited to the structures defined in the above embodiments. In another embodiment of the invention, the material assembly 200 is provided as a piston assembly. The piston assembly 600 is arranged in the pen tube 100 and the pressing assembly 400 pushes the piston assembly 600 to extrude the material out of the discharging assembly 300.

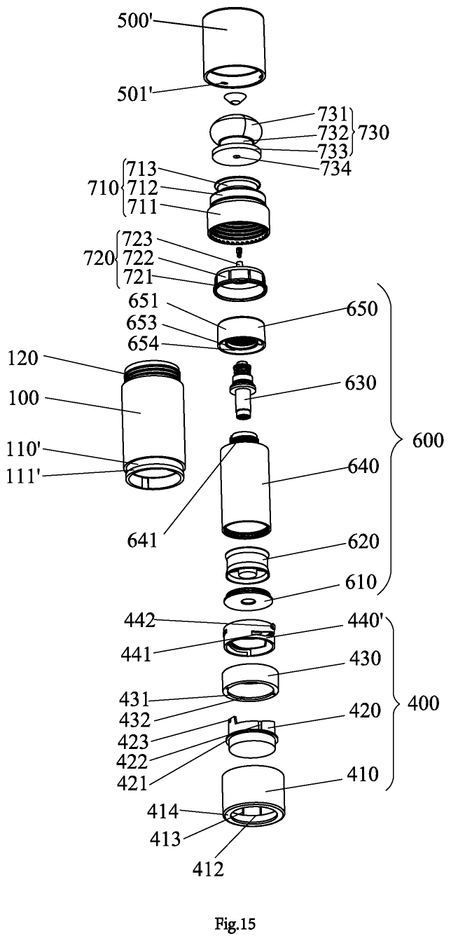

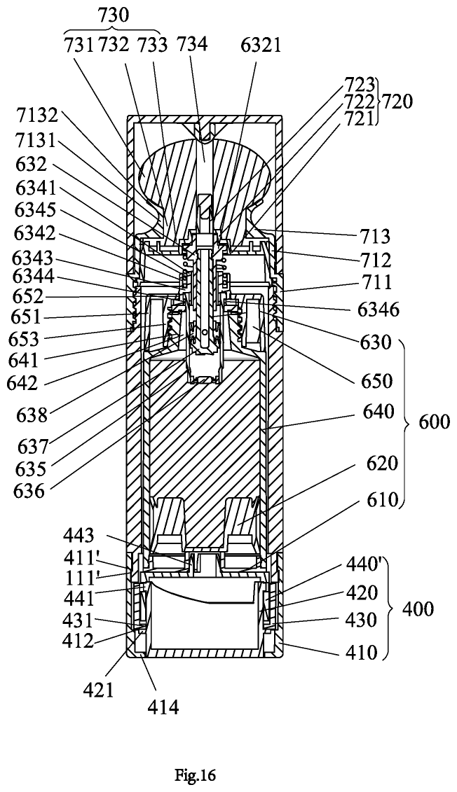

Specifically, referring to FIGS. 15 and 16, in this embodiment, the cylinder 410 connects the bottom of the pen tube 100 and rotates around it, the cylinder 410 is provided with a first clasp 111′, and the cylinder is provided with blocks 411 matching the first clasp 111′, the first clasp 111′ and the blocks hold each other, thereby preventing the cylinder 410 falling off from the pen tube 100. Specifically, as shown in FIG. 15, the bottom of the pen tube 100 is provided with a

[symbol]

connecting rings 110′, the connecting ring 110′ is provided with the first clasp 111 on the outer periphery. The inner wall of the upper opening of the cylinder 410 is provided with a block 411′. the first clasp 111′ and the block 411′ mutually hold, so that the cylinder 410′ can rotate around the connecting ring 110′, but it can not fall off from the cylinder 410′.

The piston assembly 600 comprises a piston cover 610, a piston 620, a piston tube 640, a discharging cover 650 and a vacuum pump core 630.

The top surface of the inner ring 440′ is provided with a plunger 443′. The piston cover 610 is provided with a cylinder hole 611 matching the plunger 643. The piston cover 610 seals the bottom of the piston tube 640. The piston 620 is placed in the piston tube 640 and it can slide in the piston tube 640. The piston tube 640 contains the makeup material.

The piston tube 640 is placed in the pen tube 100. The top of the piston tube 640 is provided with a thin neck 641, the thin neck 641 is provided with an external thread, and the top is provided with a tube port 642.

The discharging cover 650 includes a groove-shaped cover 651. the top of the groove-shaped cover is provided with a through hole 652. The groove-shaped cover is provided with a threaded ring 653 connected with the side walls of the outer cover 651 through a plurality of stiffeners 654. The inner wall of the thread ring 653 is provided with internal threads. The thread ring 653 connects the thin neck 641 through the external thread and the internal threads to assemble the discharging cover 650 on the top of the piston tube 640.

The vacuum pump core 630 is assembled at the through hole 652 of the discharging cover 650 and inserted and sealed the piston tube 640 through the tube port 642. Press the pressing assembly 400 to push the piston tube 640 to move in the direction of the discharging assembly 300, and then, driven by the spring 633 of the vacuum pump core 630, the piston tube 640 resets to generate negative pressure. The material in the piston tube 640 is extruded the discharging assembly 300 through the vacuum pump core 630.

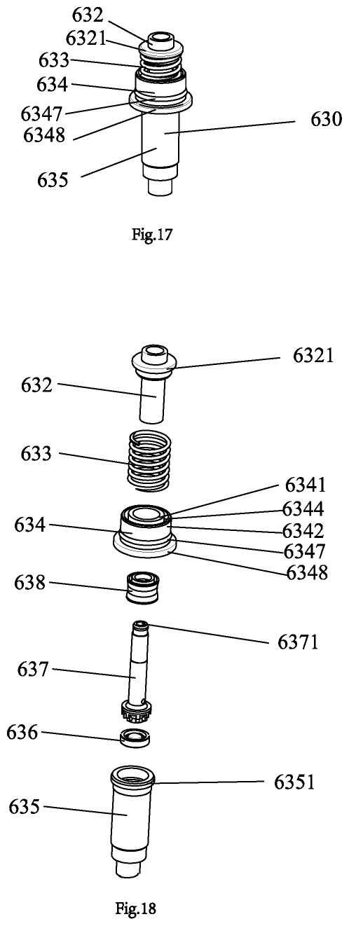

Specifically, refer to FIG. 16. FIG. 17 and FIG. 18, the vacuum pump core 630 comprises a buckle ring 634, a lower sliding cylinder 635, a valve 636, a connecting rod 637, a small piston 638, the spring 633 and the upper sliding cylinder 632. The buckle ring 634 has an inner buckle ring 6341, an outer buckle ring 6342, and a spacer 6343 connecting the inner buckle ring 6341 and the outer buckle ring 6342. The spacer 6343 separates the space between the inner buckle ring 6341 and the outer buckle ring 6342 into an up-plug interface 6344 and a down-plug interface 6345. The inner wall of the outer buckle ring 6342 extends inwards an anti-detach ring 6346, the outer wall of the outer buckle ring 6342 is provided with upper and lower clamping rings 6347 and 6348. The buckle ring 634 is inserted at the through hole 651 of the discharging cover 650, and the hole wall of the through hole 651 is stuck between the lower clamping rings 6347 and 6348, thereby preventing the buckle ring 634 falling from the discharging cover 650 and sealing the through hole 651. The material in the piston cover 610 is prevented from being extruded through the through hole 651. The top periphery of the lower sliding tube 635 is provided with an anti-detach platform 6351, and the anti-detach platform 6351 is placed in the down-plug interface 6345 and holds each other with the anti-detach ring 6346. It cannot be removed from the outer buckle ring 6342. The lower sliding cylinder 635 is provided with the valve 636, the small piston 638 and the connecting rod 637. The valve 636 is provided under the small piston 638 and is tightly connected to the lower sliding cylinder 635. The small piston 638 slides with the inner cavity of the lower sliding cylinder 635. The connecting rod 637 passes through the small piston 638, and the connecting rod 637 is provided with a through rod hole 6371 in the direction of its length. One-end of the upper sliding cylinder 632 is slide inserts into the inner cavity of the down cylinder 635, the other end is fixed with the discharging assembly 300. The upper end of the connecting rod 637 is inserted into the upper cylinder 632. The outer wall of the upper sliding cylinder 632 is provided with a cylinder limit ring 6321; the spring 633 are connected outside the upper sliding cylinder 632, one end of the spring is connected to the cylinder limited ring 6321, the other end is placed in the upper-plug interface 6344 and is connected at the spacer 6343. The inner cavity of the lower sliding cylinder 635 and the rod hole 6371 of the connecting rod 637 constitute the material hole.

Press the button over 420 of the pressing assembly 400 in the direction of discharging assembly 300 to push the piston cover 610 of the vacuum piston assembly 600, the discharging cover 650 and the vacuum pump core 630 move in the same direction, and the spring 633 is compressed. After the pressing force disappears, the spring 633 elongates to reset to push the vacuum pump core 630, the discharging cover 650, the piston cover 610 and the button cover 420 reversely move and reset, the negative pressure is generated in the piston tube 640, the material passes through the valve 636. the lower sliding cylinder 635, the rod hole 6371 of the connecting rod 637, the inner cavity of the upper sliding cylinder 632 in turn and and enters the discharging assembly 300. So repeatedly pressed, more material is enters the discharging assembly.

It should be understood that the discharging assembly 300 is not limited to the structure described in the above embodiments. In another embodiment of the present invention, reference to FIG. 14. FIG. 15 and FIG. 16, the discharging assembly 700 comprises a cover 710, a piece 720 and a cotton head 730. The cover 710 has a first connecting section 711, a second connecting section 712 and a third connecting section 713 set as a step-by-step arrangement. The inner wall of the first connecting part 711 is provided with a thread, and connects the outer part of the upper connecting head 120 through the thread. The second connecting section 712 connects the first connecting section 711 and the third connecting section 713. The third connecting section 713 has a thin neck 7131 and an external opening 7132. The cotton head 730 has a circular head 731, a neck 732 and a base 733. The circular head 731 uses natural NBR environmental protection material, soft and elastic to massage the face. The base 733 is placed in the second connecting section 712 and is matched to the third connecting section 713. The neck 732 passes through the thin neck of the third connecting section 713. The circular head 731 extends the thin neck 7131, the bottom of which and the opening of the outer opening 7132 fit. The center of the cotton head 730 is provided with the material hole 734 through the circular head 731, the neck 732 and the base 733. The piece 720 comprises a sealing cover 721, a sleeve ring 722 and an discharging rod 723; the sealing cover 721 is housed in the second connecting section 712 of the cover 710, and the upper end surface of the sealing cover 721 is provided with the sleeve ring 722. The sleeve ring 722 is arranged in the second connecting section 712 and is connected to the base 733. The discharging rod 723 is arranged on the sleeve ring 722. The discharging rod 723 is inserted in the material hole 734.

The cylinder limited ring 6321 is connected to the sleeve ring 722, and the upper sliding cylinder 632 aligns with the discharging rod 723.

Preferably, the discharging assembly 700 is also provided with a lid 500′. The lid 500′ is fastened to the cover 710 of the discharging assembly 700, thereby placing the circular head 721 in the lid 500′. Preferably, the outer wall of the second connecting part 712 of the cover 710 is provided with a clamping ring 715, and the inside wall of the lid 500′ is provided with a bump 501′, and the clamping ring 75 is interference fitted with the bump 501′ to prevent the lid 500′ falling off from the discharging assembly 700. When it needs to be opened, the external force overcomes the interference fit between the bumps 501′ and the clamping ring 715 to removes the lid 500′ from the discharging assembly 700. After the material enters the discharging assembly 700, it extrudes outside the circular head 731 of the cotton head 730 through the discharging rod 723 and the material hole 734 for using.

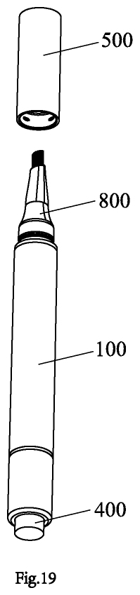

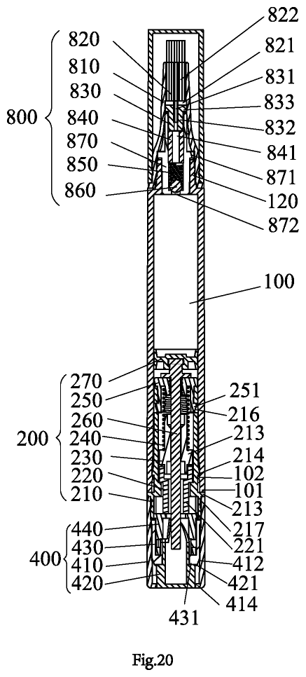

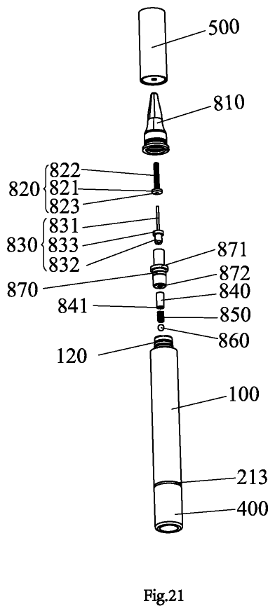

Referring to FIG. 19, FIG. 20 and FIG. 21, in another embodiment of the present invention, the discharging assembly 800 is arranged at the top of the pen tube 100, it include a pen head 810 and a brush 820 arranged within the pen head 810, a nozzle 830, a plug 840, a spring 850, a steel ball 860 and a seal plug 870. The top end of the pen tube 100 is provided with a threaded opening 120, and the pen head 810 is provided with an internal thread, which is sheathed out of the thread opening 120.

The sealing plug 870 is inserted in the thread opening 120 and sealed it. The sealing plug 870 is provided with a tube cover 871 in the middle covering the thread opening 120. The bottom of the sealing plug 870 is provided with a first through hole 872, and the inner cavity of the sealing plug 870 is hollow. The steel bead 860 is housed at the through hole 872, and the diameter of the steel bead 860 is larger than that of the through hole 872. The plug 840 is placed in the inner cavity of the sealing plug 870. The plug 840 is provided with a plug hole 841. The spring 85 is also provided between the steel ball 860 and the plug 840. The nozzle 830 includes a plug end 831, a thin tube end 832, and an end cover 833 between the two, the insertion end 831 inserts the sealing plug 870, the thin tube end 832 insert the brush 820. The end cover 833 covers the seal plug 870. The brush 820 includes a brush seat 821 and soft hair 822 arranged on the brush seat 821. The brush seat 821 is provided with a second through hole 823. The thin tube end 832 insert into the soft hair 822 through the second through hole 823. The pen tube 100 contains fluid material, which is flows out by pressing the pressing assembly 400 and the material assembly 200 or 700, the fluid material flows through the threaded opening 120, the first through hole, the cavity of the sealing plug, the plug hole of the plug, the thin tube and flows into the brush, the brush infiltrate fluid material ans used for making up.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A rotary pressing cosmetic pen comprising:
a pen tube including front portion and rear portion spaced in an axial direction and containing makeup material;
a discharging assembly arranged at said front portion of said pen tube;
wherein a pressing assembly arranged at said rear portion of said pen tube;
wherein a material assembly received in said pen tube;
wherein said pressing assembly including a cylinder, a button cover, an outer ring and an inner ring; said cylinder rotationally connecting to said rear portion of said pen tube; said outer ring fixed in said cylinder; said button cover is inserted into said outer ring and stucked along circumferential direction of said outer ring; one end of said inner ring is inserted between said outer ring and said button cover, the other end of said inner ring is inserted into said rear portion of said pen tube and stucked along circumferential direction of said pen tube; said inner ring is also provided with spiral grooves; said button cover is provided with clasps inserted into said spiral grooves and slide in it; said cylinder is rotated to drive said outer ring and said button cover to rotate; said clasps slide up and down in said spiral grooves, thus said button cover is retracted into or extended out from said cylinder.

2 [symbol] The rotary pressing cosmetic pen according to claim 1, wherein said pen tube contained fluid material, rotating said cylinder to drive said button cover to extend out from said pen tube, then pressing said button cover to retract into said said pen tube and push said inner ring and said material assembly, causing said material in said pen tube to be extruded out through said discharging assembly; then said material assembly is reset under action of a spring to reverse push said inner ring and said button cover extending out from said cylinder; then reversely rotating said cylinder to drive said button cover to retract into said pen tube; said button cover is limited protection within said cylinder.

3 [symbol] The rotary pressing cosmetic pen according to claim 1, wherein said cylinder is sheathed out of said rear portion of said pen tube with a connecting tube, said connecting tube is provided with a first clasp, said cylinder is provided with blocks, said blocks and said first clasp hold each other to prevent said cylinder from falling off from said connecting tube.

4 [symbol] The rotary pressing cosmetic pen according to claim 1, wherein said outer ring is placed in said cylinder and held by said cylinder; its inner wall of said cylinder is provided with a second clasp holding said outer ring to prevent said outer ring from falling off said cylinder; its inner wall of said cylinder is also evenly distributed with a plurality of first bulges along its axial direction, and its outer wall of said outer ring is also provided with a plurality of second bulges along its axial direction, said first bulges and said second bulges hold each other to prevent said outer ring from rotating.

5 [symbol] The rotary pressing cosmetic pen according to claim 4, wherein said outer ring is arranged outside of said button cover, said outer ring and said button cover are placed in said cylinder; said button cover can slide in said outer ring along its axial direction so that bottom of said button cover extends out from or retracts into said cylinder.

6 [symbol] The rotary pressing cosmetic pen according to claim 5, wherein said button cover is provided with a third clasp in middle of its outer wall; its bottom periphery of said cylinder extends inward to form a first step ring; said first step ring blocks said third clasp thereby preventing said button cover from falling off said outer ring; its bottom periphery of said outer ring extends inward to form a second step ring matching with said outer wall of said button cover and blocking said third clasp.

7 [symbol] The rotary pressing cosmetic pen according to claim 6, wherein said second step ring is provided with a sliding block; its outer wall of said button cover is provided with a sliding slot matching with said sliding block, thereby said button cover can move up and down along its axis in said outer ring, but it can not rotate along its circumferential direction.

8 [symbol] The rotary pressing cosmetic pen according to claim 7, wherein said inner ring is provided with a second sliding block, and said inner wall of said opening of said connecting tube is provided with a second sliding slot matching with said second slide block.

9 [symbol] The rotary pressing cosmetic pen according to claim 3, wherein said material assembly includes said connecting tube, its outer wall of said connecting tube is provided with a large ring and a small ring; said large ring adapts opening of said rear portion of said pen tube; its inner wall of said pen tube is provided with a limited ring matched with said small ring; so that said connecting tube and said pen tube hold each other;
said connecting tube is provided with a convex zone on its outer wall close to said small ring, and its inner wall of said pen tube is provided with convex strips matching with said convex zone, said convex strips and said convex zone hold mutually, thereby preventing said connecting tube from rotating in said pen tube.

10 [symbol] The rotary pressing cosmetic pen according to claim 9, wherein said material assembly also includes a lower rotating shaft, an upper rotating shaft, a spring, a cylinder cover, a rod and a piston; said lower rotating shaft and said upper rotating shaft are placed in said connecting tube; said connecting tube is provided with an inner convex ring; its upper part of said inner convex ring is provided with a vertical tooth portion; said lower rotating shaft has a lower cylinder and a lower tooth portion arranged on said lower cylinder; said lower tooth portion and said vertical tooth portion are clamped mutually to prevent said lower rotating shaft from rotating in its circumferential direction, said lower cylinder passes through said inner convex ring touch said inner ring.

11 [symbol] The rotary pressing cosmetic pen according to claim 10, wherein its top of said lower tooth portion is arranged as a continuous V-shaped tooth; said upper rotating shaft has an upper cylinder and a limit plate arranged in middle of said upper cylinder, from which extends said upper tooth portion; said upper cylinder inserts said lower tooth portion, and said bottom of said upper tooth portion is an oblique tooth matching said V-shaped tooth.

12 [symbol] The rotary pressing cosmetic pen according to claim 10, wherein said connecting tube is also provided with a wall hole above said convex zone; said upper end of said connecting tube is provided with said connecting cover, said connecting cover is provided with clasps to connect said wall hole; said connecting cover is also provided with a thread hole at its center; said spring is sheathed out of said upper rotating shaft with one end against said limit plate and the other end against said connecting cover.

13 [symbol] The rotary pressing cosmetic pen according to claim 12, wherein said rod has a threaded body portion, its opposite side faces of said threaded body portion are set as planes; one end of said thread body portion is a cylinder end, the other end of said thread body portion is provided with an end cover, and a top cover is arranged above said end cover; said upper rotating shaft is provided with a flat cavity; said threaded body portion passes through said connecting cover and fits with said threaded hole; said thread body portion passes through said flat cavity and said lower rotating shaft and extends into said inner ring.

14 [symbol] The rotary pressing cosmetic pen according to claim 12, wherein said piston is slide arranged in said pen tube, which is pushed by said top rod end of said rod and slides up in said pen tube.

15 [symbol] The rotary pressing cosmetic pen according to claim 1, wherein said discharging assembly is arranged at one end of said pen tube; said end of said pen tube is provided with a threaded port; said discharging assembly comprises a nozzle and a pen head; said nozzle includes a thread tube and a thin tube portion arranged on said thread tube, said thread tube is connected with said threaded port; said pen head are fixed on said thread tube.

16 [symbol] The rotary pressing cosmetic pen according to claim 15, wherein said pen head is shaped in a sloping surface, a arc surface or a spherical sphere.

17 [symbol] The rotary pressing cosmetic pen according to claim 1, wherein said discharging assembly is arranged at said front portion of said pen tube, it includes a pen head, a brush arranged within said pen head, a nozzle, a plug, a spring, a steel ball and a seal plug; said front portion of said pen tube is provided with a threaded opening, and said pen head is provided with an internal thread, which is sheathed out of said thread opening;
said sealing plug is inserted in said thread opening and sealed it, said sealing plug is provided with a tube cover in its middle covering said thread opening; its bottom of said sealing plug is provided with a first through hole, and inner cavity of said sealing plug is hollow; said steel bead is received at said through hole, said plug is placed in inner cavity of said sealing plug; said plug is provided with a plug hole said spring is also provided between said steel ball and said plug, said nozzle includes a plug end, a thin tube end, and an end cover between them, said insertion end inserts said sealing plug, said thin tube end insert said brush; said end cover covers said seal plug, said brush includes a brush seat and soft hair arranged on said brush seat, said brush seat is provided with a second through hole, said thin tube end insert into said soft hair through said second through hole, said tube contains fluid material, which is flows out by pressing the pressing assembly and said material assembly, said fluid material flows through said threaded opening, said first through hole, said cavity of said sealing plug, said plug hole of said plug, said thin tube and flows into said brush, said brush infiltrate fluid material ans used for making up.

18 [symbol] The rotary pressing cosmetic pen according to claim 1, wherein said said material assembly is a piston assembly, including a piston cover, a piston, a piston tube, a discharging cover and vacuum pump core;
its top surface of said inner ring is provided with a plunger, said piston cover is provided with a cylinder hole matching with said plunger; said piston cover seals bottom of said pen tube; said piston is placed in said pen tube and it can slide in the pen tube; said pen tube contains makeup material; said piston tube is contained in said pen tube, its top of said pen tube is provided with a thin neck, said thin neck is provided with an external thread, and its top of said thin neck is provided with a tube port;
said discharging cover includes a groove-shaped cover with a through hole at its top and a threaded ring in it, said threaded ring connected with side walls of said outer cover through a plurality of stiffeners;
its inner wall of said thread ring is provided with internal threads sheathed out of said thin neck through said external thread and said internal threads to assemble the discharging cover on said top of the pen tube;
said vacuum pump core is assembled at said through hole of said discharging cover and inserted and sealed said piston tube through said tube port; pressing said pressing assembly to push said piston tube to move towards the discharging assembly, and then, driven by spring of said vacuum pump core, said piston tube resets to generate negative pressure; said material in said pen tube is extruded out of said discharging assembly through said vacuum pump core.

19 [symbol] The rotary pressing cosmetic pen according to claim 1, wherein said discharging assembly comprises a cover, a piece and a cotton head; said cover has a first connecting section, a second connecting section and a third connecting section set as a step-by-step arrangement; its inner wall of said first connecting part is provided with a thread, and connects its outer part of said upper connecting head through said thread; said second connecting section connects said first connecting section and said third connecting section; said third connecting section has a thin neck and an external opening; said cotton head has a circular head, a neck and a base; said base is placed in said second connecting section and is matched with said third connecting section; said neck passes through said thin neck of said third connecting section; said circular head extends said thin neck, bottom of thin neck and opening of said outer opening fit each other; center of said cotton head is provided with material hole through said circular head, said neck and said base, said piece comprises a sealing cover, a sleeve ring and an discharging rod; said sealing cover is housed in said second connecting section of said cover, and its upper end surface of said sealing cover is provided with said sleeve ring; said sleeve ring is arranged in said second connecting section and is connected to said base; said discharging rod is arranged on said sleeve ring; said discharging rod is inserted in said material hole.
